(19) United States
(12) Patent Application Publication
(10) Pub. No.: US 2020/0327581 A1
(43) Pub. Date: Oct. 15, 2020

(54) METHOD AND SYSTEM FOR IMPLIED REVENUE RECOGNITION

(71) Applicant: Salesforce.org, San Francisco, CA (US)

(72) Inventors: Pedro DAL COL, Sacramento, CA (US); Carlos RAMIREZ MARTINEZ-EIROA, Naperville, IL (US); Wei ZHANG, Vancouver (CA)

(21) Appl. No.: 16/383,424

(22) Filed: Apr. 12, 2019

(51) Int. Cl. G06Q 30/02; G06Q 40/00; G06Q 10/06

(52) U.S. Cl. CPC G06Q 30/0279; G06Q 10/06312; G06Q 40/125

(57) ABSTRACT

A computer implemented method of revenue recognition for a donation management system, the method including determining a difference in a payment schedule as a pledge level revenue delta for a donation, compiling a schedule of payments and installments for the donation, and adjusting revenue amounts for at least one installment in the schedule of installments to account for the pledge level revenue delta.

### TECHNICAL FIELD

One or more implementations relate to the field of donation management systems; and more specifically, to manage changes to payments via implied revenue recognition.

### BACKGROUND

Nonprofit organizations and similar entities are often reliant on donations to financially support their operations. These donations are often promised to the nonprofit organization before the money is given to the nonprofit. In some cases, the promised money is paid in installments over time. These installments are scheduled and tracked by the nonprofit. The donors however do not always adhere to the schedule or make payment amounts according to the schedule. This creates ongoing work for the nonprofit to track and adjust the payment schedule.

In many cases, nonprofits utilize accrual accounting to track donations. Under accrual accounting, the nonprofits are required to treat promised donations as “revenue” at the time the amounts of the donations are promised. That revenue, even if no money has actually been received, needs to be entered in the accounting system and reported to the appropriate revenue agency (e.g., the internal revenue system (IRS) in the United States). Since this means that revenue might be recognized, recorded, and reported to the appropriate agency before it is received, once the actual payments come in, that money must be matched to the recorded and reported revenue. This is a straightforward task if donors pay the amount of money that they promised, according to the schedule they agreed to, and designate it as promised (i.e., the money is typically promised to specific target funds, which can be later changed). If that is not the case, because the donor modifies the agreed payment schedule, amount, or target fund anytime after their initial commitment, then the accounting and tracking process is complicated for the nonprofit to manage.

There are three components to revenue: amount, due date, and fund allocation. All three components need to line up when matching payments to revenue. A mismatch in any of these three areas must be reconciled. In order for a donation tracking and management system to support accrual accounting, it needs to track revenue and the actual payments separately. Such a system would force users to enter what is promised in a revenue schedule, and separately, what is paid in a payment schedule or log. However, some systems store both promised payments and received payments together in one payment schedule. The way such systems work is each payment can be either paid or unpaid in the payment schedule. Unpaid (promised) payments represent revenue and paid payments represent actual money.

Storing both revenue (promised payments) and actual payments in the same place works if what was originally promised matches what is received. The problem arises when the donor deviates from what was promised, in that case the user of the donation management and tracking system, updates the existing unpaid payment record to reflect the actual money received. When that happens, revenue history is lost and it is replaced by the actual payment. This causes issues when matching that payment to existing revenue since the revenue that was recognized is no longer tracked in the donation management system but that revenue was previously sent to accounting and most likely also reported to the appropriate revenue agency.

In the case when there is a mismatch in a donation management system that uses a combined revenue/payment schedule, the reconciliation cannot be automated and is usually handled external to the donation management system by the accounting department. This external management process is not handled in a methodical manner and is often performed incorrectly or inconsistently due to the missing information which forces the accounting department to fill in the gaps with guesses due to the lack of information.

Donation management systems including accounting management systems can be services offered in a multi-tenant cloud computing platform. A multi-tenant cloud computing platform supports one or multiple services that are made available to tenants of the multi-tenant cloud computing platform. The services are sets of functions, applications, and/or resources that may be made available on-demand to the tenants of the multi-tenant cloud computing platform. The tenants of the multi-tenant cloud computing platform can leverage these services to support their organization. Thus, an organization of a tenant does not need to be concerned with building and/or maintaining the provided services, but instead makes use of the services when needed (e.g., in response to a demand from a tenant). The services may communicate with each other and/or with one or more electronic devices external to the multi-tenant cloud computing platform via one or more Application Programming Interfaces (APIs) (e.g., a Representational State Transfer (REST) API).

The multi-tenant cloud computing platform can also provide a set of resources to tenants. For example, the resources may include a set of databases and the services use data stored within the set of databases. The set of databases may each comprise one or more database objects that are managed by a Database Management System (DBMS). Each database object may include a number of records and each record may comprise a set of fields.

### BRIEF DESCRIPTION OF THE DRAWINGS

The following figures use like reference numbers to refer to like elements. Although the following figures depict various exemplary implementations, alternative implementations are within the spirit and scope of the appended claims. In the drawings:

FIG. 1 is a block diagram of a donation management system that includes an accounting management system that implements an implied revenue recognition process.

FIGS. 2A and 2B are a flowchart of one embodiment illustrating an implied revenue recognition process.

FIG. 3 is a flowchart of one embodiment illustrating a new revenue amount computation process.

FIGS. 4A-4E are a flowchart of one example implementation of a process for implied revenue recognition.

FIGS. 5A and 5B are diagrams of a multi-tenant distributed cloud computing platform supporting the donation management system including the accounting management system.

### DETAILED DESCRIPTION

The following description describes a method and donation management system that provides implied revenue recognition. The process and system enable a modification to the donation management system to support accrual accounting. If the donation management system was not originally designed to support accrual accounting, then the donation management system does not track a payment schedule and a revenue schedule separately. Rebuilding that system to work with accrual accounting would be very costly and time consuming. The embodiments modify such donation management systems to track revenue by separating promised donations (revenue) from actual payments made due to modifications in the payment (including payment date, allocation, and increases or decreases in the amount of the payment), which is not supported by these donation management systems but is required to support accrual accounting. The embodiments provide a process and system that implies revenue, to account for those aforementioned changes when paid or promised payments are modified in the payment schedule without requiring changes to the user interface or to the application programming interfaces (APIs) of the donation management system. The embodiments synchronize the revenue schedule with the changes made in the payment schedule for accurate reporting and tracking of donations.

The embodiments support accrual accounting and use a data model that tracks revenue independently of the payment schedule. The embodiments also allow the user to interact with the payment schedule and automatically modify the revenue schedule as needed to satisfy accrual accounting requirements. Existing donation management systems that keep track of revenue and payments in a combined way cannot properly support accrual accounting. In these systems, accrual accounting reconciliation cannot be automated or handled in a consistent manner. A manual ad hoc correction process is performed that is often incorrect and always inconsistent due to missing information which forces an accounting department to fill in the gaps and rely on guesswork.

Alternative possible updates to existing donations management system to keep track of separate payment schedule and revenue schedule require significant modifications, are expensive and have other disadvantages. One of those disadvantages is that users will have to change how they interact with the donation system to enter revenue separate from payments which also means that any APIs for integration with other interfacing systems (like automated payment processing systems) will need to be updated and very likely those other interfacing systems will need to be updated too. Also, future features and integrations will have to be designed twice, once for organizations that do not use accrual accounting and once for organizations that do. The embodiments solve these issues by retrofitting a donation management system to properly work with accrual accounting but with minimal changes and without making changes to the user interface or API's.

In the following description, numerous specific details such as implementations, types and interrelationships of system components, and logic partitioning/integration choices are set forth in order to provide a more thorough understanding. It will be appreciated, however, by one skilled in the art, that the invention may be practiced without such specific details. In other instances, control structures, logic implementations, opcodes, means to specify operands, and full software instruction sequences have not been shown in detail since those of ordinary skill in the art, with the included descriptions, will be able to implement what is described without undue experimentation.

References in the specification to “one implementation,” “an implementation,” “an example implementation,” etc., indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, or characteristic is described in connection with an implementation, it is submitted that it is within the knowledge of one skilled in the art to affect such feature, structure, or characteristic in connection with other implementations whether or not explicitly described.

Bracketed text and blocks with dashed borders (e.g., large dashes, small dashes, dot-dash, and dots) may be used herein to illustrate optional operations and/or structures that add additional features to some implementations. However, such notation should not be taken to mean that these are the only options or optional operations, and/or that blocks with solid borders are not optional in certain implementations.

In the following description and claims, the term “coupled,” along with its derivatives, may be used. “Coupled” is used to indicate that two or more elements, which may or may not be in direct physical or electrical contact with each other, co-operate or interact with each other.

The operations in the flow diagrams are described with reference to the exemplary implementations in the other figures. However, the operations of the flow diagrams can be performed by implementations other than those discussed with reference to the other figures, and the implementations discussed with reference to these other figures can perform operations different than those discussed with reference to the flow diagrams.

While the flow diagrams in the figures show a particular order of operations performed by certain implementations, it should be understood that such order is exemplary (e.g., alternative implementations may perform the operations in a different order, combine certain operations, overlap certain operations, etc.).

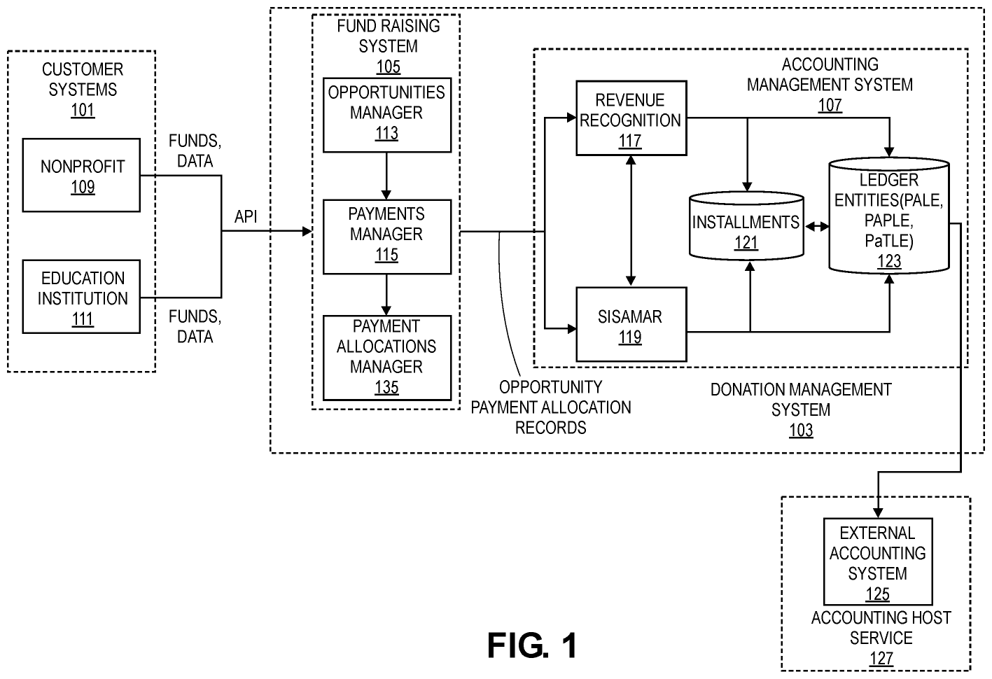

FIG. 1 is a block diagram of a donation management system that includes an accounting management system that implements an implied revenue recognition process. The donation management system 103 can include additional elements and subsystems that are not illustrated or further discussed herein. The most relevant components of the donation management system 103 and related systems are shown for sake of clarity and conciseness. One skilled in the art would appreciate that these systems and components would include additional components and systems.

An accounting management system 107 is illustrated as part of a donation management system 103 and interfacing with a fundraising system 105 as well as an external accounting system 125 by way of example and not limitation. The functions of the accounting management system 107 could be separately implemented or integrated into other components in other configurations and arrangements. The donation management system 103 interfaces with a set of customer systems 101 such as nonprofits 109 and educational system 111. Any number of customer systems 101 can interface with separate instances of the fundraising system 105 via an API of the donation management system 103. The donation management system 103 can be hosted by a multi-tenant cloud-based service.

The customer systems 101 provide an interface or ‘front-end’ to access and enter data into the donation management system 103. A user of a customer system 101 can set up and enter fund and payment information into the fundraising system 105. The customer systems 101 can be specialized local client applications or general purpose applications such as web browsers. In some embodiments, the customer systems 101 interact with the fundraising system via existing APIs that are not modified to accommodate accrual accounting.

The fundraising system 105 can include multiple functions including opportunities (e.g., gifts) manager 113, payments manager 115, and payment allocation manager 135. In the fundraising system 105, an opportunity, also referred to as donation or pledge, is managed by the opportunities manager 113. The opportunities manager 113 maintains an opportunity record that represents a specific donation in the fundraising system 105. The opportunity record stores the total amount promised. Additional information about the opportunity such donor information and related data can also be stored in the opportunity record. This total amount is used to cap the total scheduled implied revenue that the donation management system can recognize.

The payments manager 115 maintains a payment schedule. The payment schedule is a data structure that is a collection of payment records for payments received for a specific opportunity or donation. In the fundraising system 105 payment schedule represents what the donor has either promised or has paid. This is a combined view of revenue and actual payments. The embodiments provide a mechanism to track those promised payments and actual payments separately. As discussed further herein below, the revenue recognizer 117 monitors the payment schedule and detects any changes to it to determine if they should affect recognized revenue. The payment records are data structures used to store amount, and date a payment was paid or expected to be paid, among other data. They can be scheduled payments (unpaid) or actual payments (paid).

A payment allocation manager 135 manages payment allocation records. Payment allocation records are records that represent how much of each payment will be allocated to each general accounting unit (GAU) or fund. The GAU represents a fund (e.g., in fund accounting which is required for nonprofits). The embodiments support both fund accounting and accrual accounting. A fund is an accounting representation of a project or cause that the donation is allotted to support. Each GAU can be a record with the allotment details for donations and payments.

The fundraising system 105 makes accessible or passes the opportunity records, payment records, and allocation records to the accounting management system 107. The functions of the accounting management system 107 include a revenue recognizer 117 and a split into installments, split into allocations, match to recognize revenue, and reconcile (SISAMAR) 119. The SISAMAR 119 functions to split payments into installments, split installments into allocations, match allocations to recognized revenue, and to reconcile. Thus, the SISAMAR implements a method to match payments to revenue.

The revenue recognizer 117 processes opportunity records, payment records, and payment allocation records to identify revenue that is not explicitly provided to the donation management system 103. The revenue recognizer 117 accounts for changes in the payment date, allocation, and amount (increase or decrease) when paid or promised payments are modified in the payment schedule without making changes to the user interface or to the API's. The revenue recognizer will synch the revenue schedule with the changes made in the payment schedule by implying what effect those changes should have on revenue. The revenue recognizer enables end users and other customer systems to interact only with the payment schedule (i.e., not having to input corresponding revenue information). The revenue recognizer will then automatically keep track of revenue by figuring out or implying it from those payment schedule interactions.

The revenue recognizer 117 does not need to make adjustments when what is promised matches exactly what is delivered by a donor. In that case the revenue recognizer duplicates the expected payment schedule into the revenue schedule. However, when a donor changes her mind after the initial commitment, the payment schedule is updated and the revenue recognizer will imply, by analyzing those changes, how and if any of those changes need to be reflected in the revenue schedule.

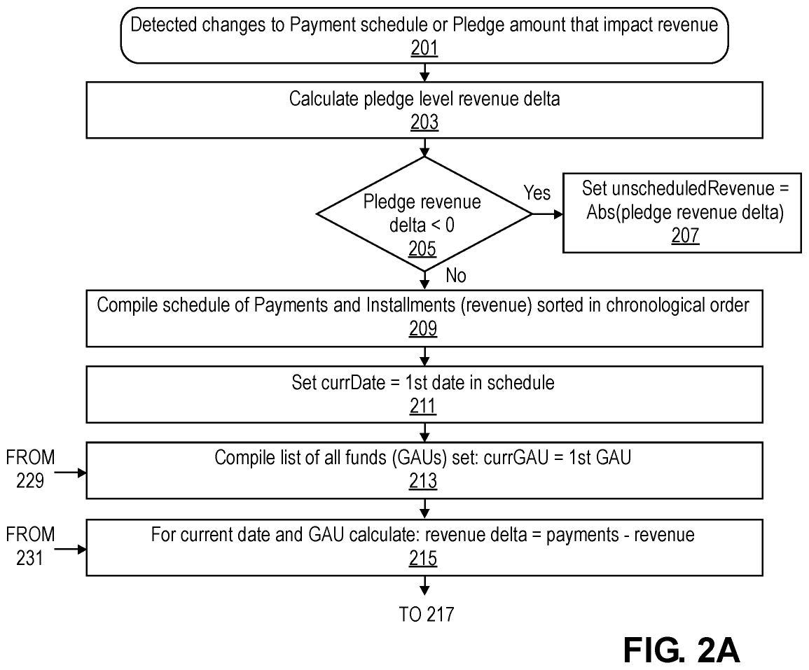

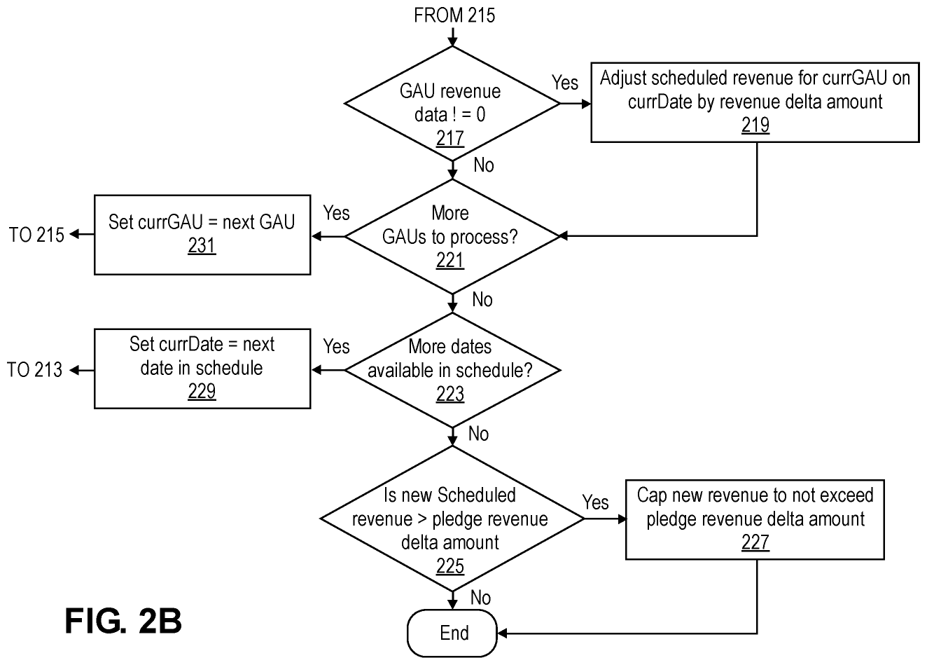

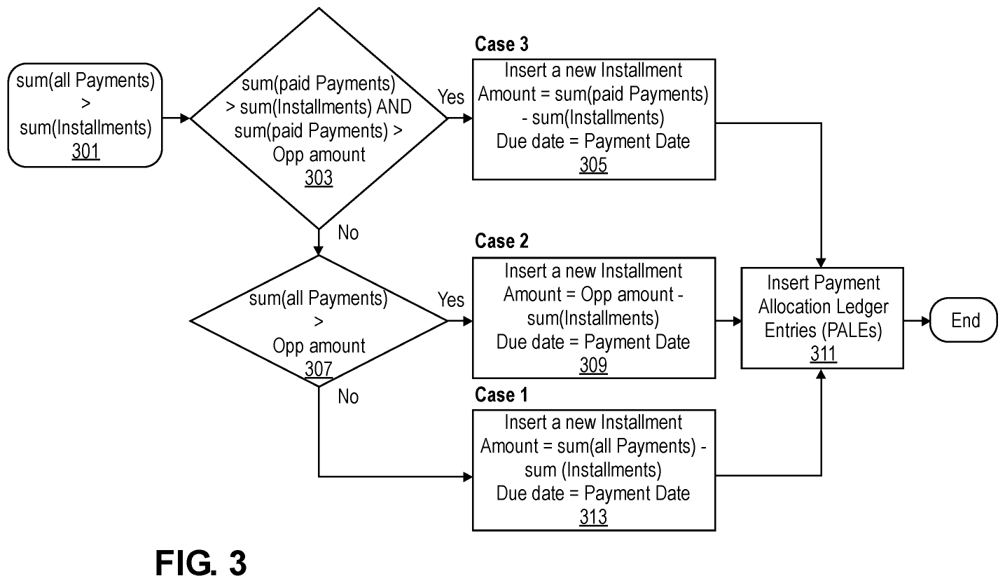

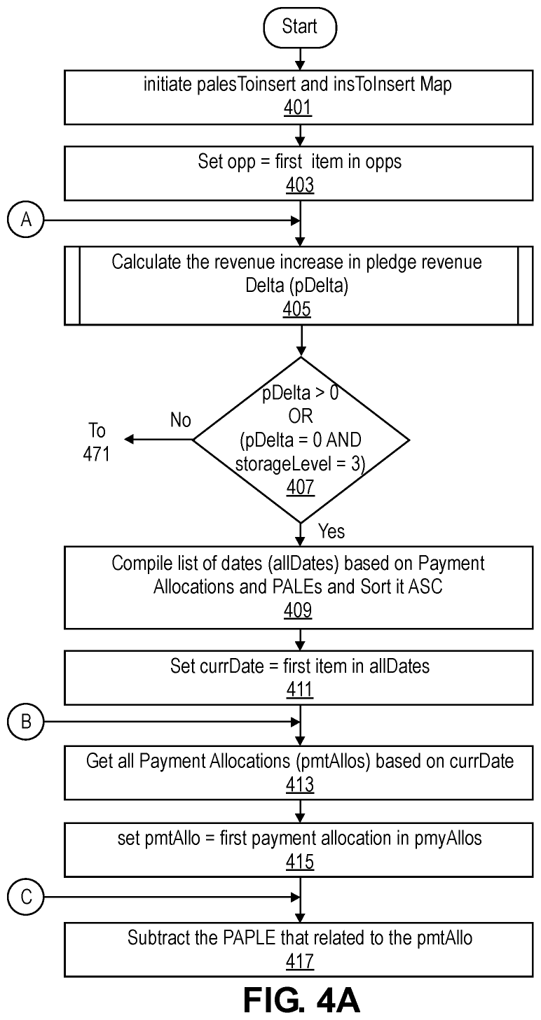

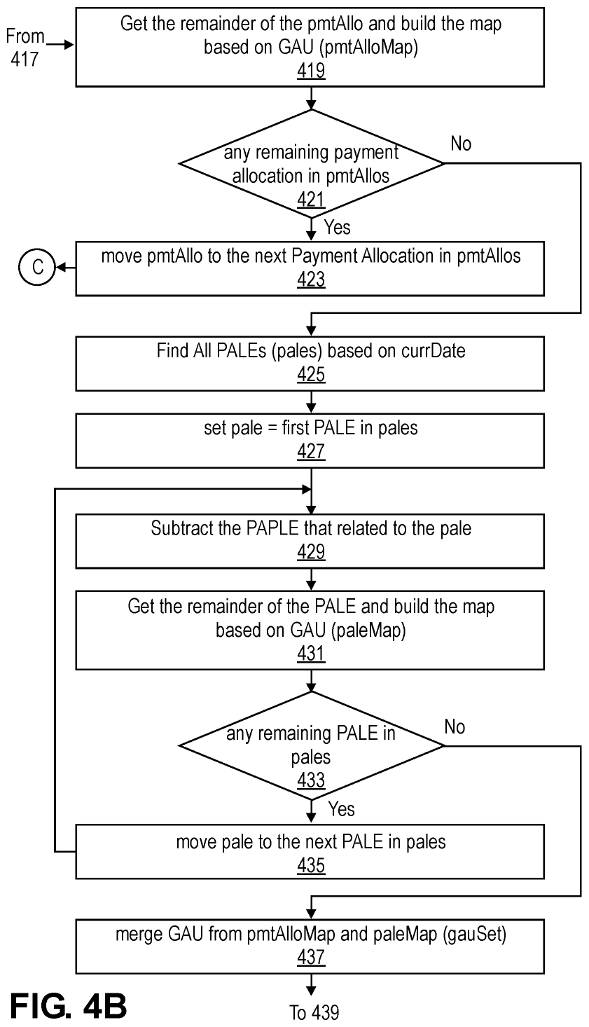

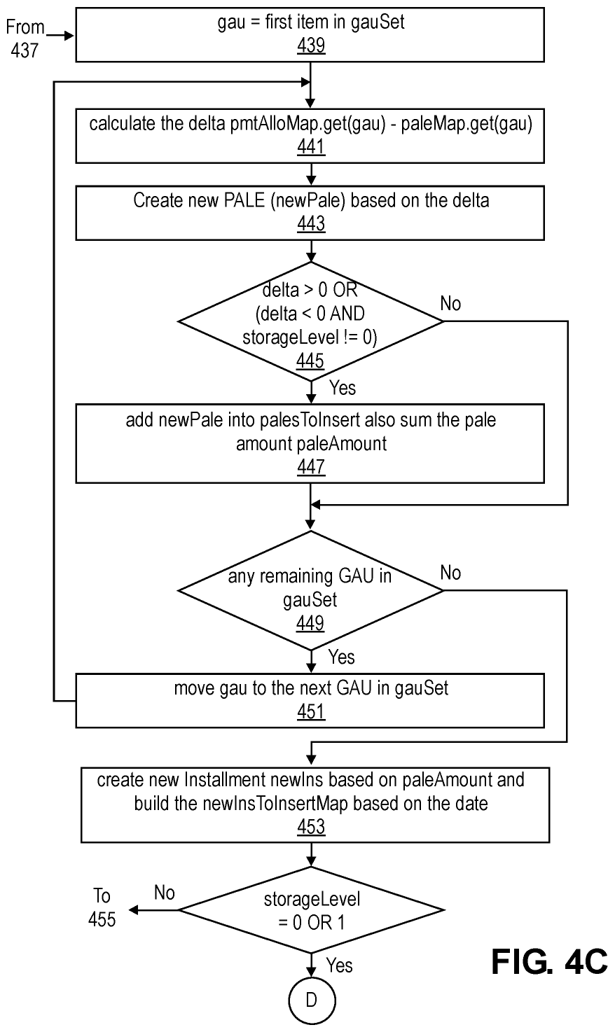

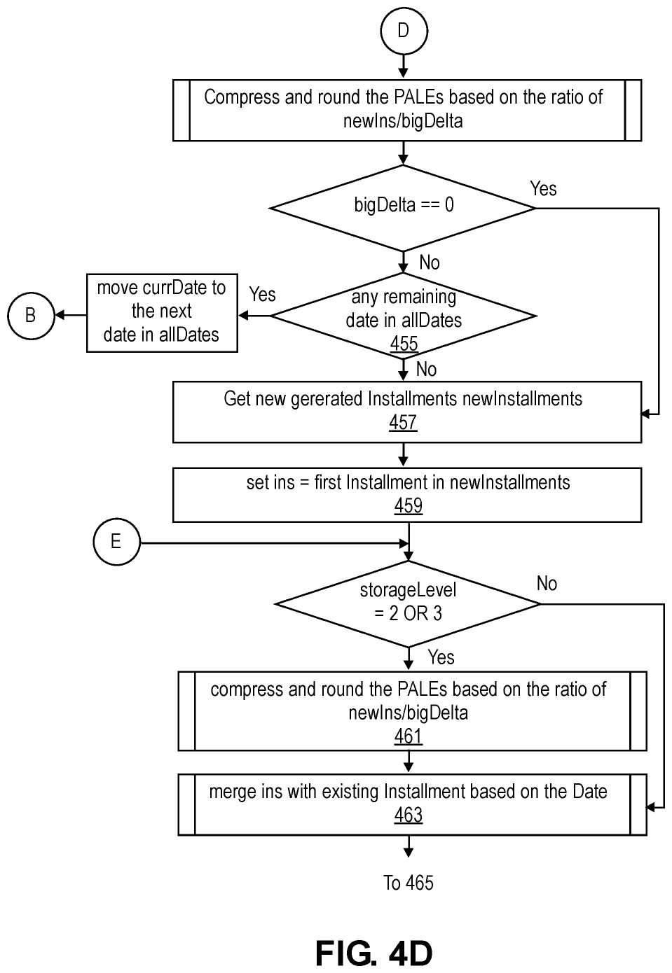

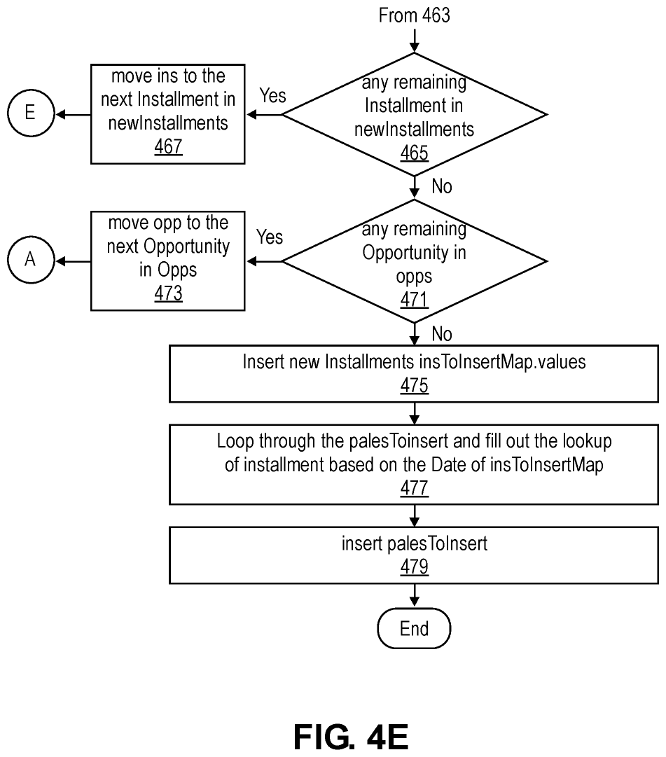

In general, any changes to one of the three components of revenue (amount, date, or allocation) can result in changes to the revenue schedule. When one or more of those components are modified in the payment schedule the revenue recognizer determines if any of those changes need to be reflected on the revenue schedule and how those changes will be implemented. The operations of the revenue recognizer are described herein below in reference to FIGS. 2A and 2B and a detailed example is described below in relation to FIGS. 3 and 4A-4E.

Examples of what can be implied from changes in the payment schedule include overpayments at a pledge level, overpayments at an installment level, and re-allocations of funds for future payments. An overpayment at the pledge level occurs if a donor decides to overpay the last payment in the schedule, such that the overpayment will result in an increase in the overall donation (also referred to as a pledge or opportunity). For example, a donor promises $200 in 2 payments of $100. The first payment comes in as promised, but when the second payment arrives, it is for $150. In this case the revenue recognizer can imply that there is $50 in new revenue that needs to be added to the revenue schedule.

An overpayment at the installment level occurs in the case that a donor overpays a payment other than the final payment. As discussed further herein below, an installment is a record that represents revenue for a given date without taking into consideration how the will be allocated. In the case of an overpayment, the revenue recognizer analyzes the impact of this change before it can determine if the change will impact the revenue schedule. For example, if a donor promised two payments of $100 each and overpays the first one by $110 (i.e., the initial payment is $210), this will result in $10 of new revenue. But if the donor overpays the same (i.e., first) payment by $10 (e.g., the initial payment is $110), the revenue recognizer cannot yet determine if this change will ultimately result in a donation overpayment or if the donor was just paying ahead. In this case, the revenue recognizer will hold off modifying revenue until sufficient money comes in to make that determination.

A re-allocation of funds for a future payment occurs where a donor pledges two payments of $100 and originally allocates her donation equally split into two funds (e.g., a music department and computer science department at a recipient university), the donor makes the first payment with that allocation, and then decides to update her allocation for the second payment so that 100% goes to the music department. In this case the revenue recognizer needs to update the revenue schedule to reduce $50 of revenue from what was promised to the computer science fund and increase by $50 the revenue promised towards the music department fund.

The revenue recognizer 117 interacts with a data store for management of installment records 121 and ledger entries 123. Installments records are data structures that represent revenue for a date without taking into consideration how it will be allocated. Each installment record tracks total revenue amount and date. Revenue allocation is represented by a pledge allocation ledger entry (PALE). A ledger entry is an entry in a data structure that represents information to be sent to an accounting system from the accounting management system 107. There are three types of ledger entries, a PALE, a payment transaction ledger entry (PaTLE), and a pledge allocation payment ledger entry (PAPLE). The PALE is a data structure that represents how much of each installment will be allocated to each GAU or fund. The PALE represents revenue and tracks all three components of revenue (i.e., amount, date, and allocation). The PaTLE is a copy of the information contained in the payment record of the fund raising system 105, which can be sent to accounting instead of the payment records. PaTLEs are created so that transactional information can be sent to external accounting systems without having to rely on payment records since payment records might need to be updated after they are posted. The PAPLE is a data structure that represents actual money that will be matched to revenue (i.e., a PALE).

The accounting management system 107 can interface with or provide access to installments and/or ledger entries for accounting system 125. The accounting systems 125 can utilize this information to perform accounting activities without having to rely on manual guesswork to correlate payment information, donation information, and revenue information. The accounting system 125 can be a part of the donation management system 103 or can be a separate system (e.g., an external accounting system 125 provided by an accounting host service 127).

FIGS. 2A and 2B are a flowchart of one embodiment illustrating an implied revenue recognition process provided by a revenue recognizer. The process flow illustrated in FIGS. 2A and 2B is an overview of the process for the sake of clarity. FIGS. 3 and 4A-4E provide detailed examples that apply the principles of the process. The implied revenue recognition process improves the revenue schedule accuracy by continuously updating it based on detected changes to the payment schedule. The implied revenue recognition process can be used for retrofitting existing accounting management systems or other accounting systems to properly handle accrual accounting. One skilled in the art would understand that the principles and general steps of the implied revenue recognition process could also be applied to other data sets. For example, the principles and process of the implied revenue recognition process can be applied to grant management systems or other outgoing funds instead of incoming funds. In such cases, instead of implying revenue this method would be used to imply and recognize liabilities. The following overview and examples describe the case of implied revenue recognition for sake of clarity.

The implied revenue recognition process can continuously monitor to detect changes to payment schedules or pledge (i.e., donations or opportunity) amounts (Block 201). The implied revenue recognition process can receive notifications of changes from the fund raising system or can regularly poll or search the payment schedules, related logs or similar information to detect the changes. The implied revenue recognition process can trigger more specifically for any changes that may affect revenue (e.g., updates to enter expected timely payments can be ignored). After a payment schedule change is detected, the change in donation or pledge revenue (i.e., the delta) is calculated (Block 203). FIG. 3 provides an example pledge revenue delta calculation process. The difference between the total scheduled payments and the total revenue that has been recognized is the amount of new revenue that the implied revenue recognition process will add to the revenue schedule (with some exceptions).

In the example of FIG. 3, the sum of all payments in a payment schedule is compared to the sum of all the corresponding installments (Block 301). If the sum of all payments is not greater than the sum of all installments, then the process does not trigger continued execution. If the sum of all payments does exceed the sum of all installments, then the pledge revenue delta calculation process determines if the sum of all paid payments exceeds the sum of all installments and at the same time the sum of all paid payments exceeds the donation (i.e., pledge or opportunity) amount (Block 303). If this case is true, then the delta calculation applies case 3 and inserts a new installment amount that is equal to the sum of all paid payments minus the sum of all installments and sets the due date to be the last payment date (Block 305). One or more payment allocation ledger entries (PALEs) are inserted into the ledger entries that corresponds to the new installment (Block 311), before the delta calculation process completes.

If the sum of all paid payments is not greater than the sum of all installments or the sum of all paid payments is not greater than the donation (i.e., the opportunity), the delta calculation process checks if the sum of all payments is greater than the donation amount (Block 307). If the sum of all payments is greater than the donation amount, then the delta calculation process applies case 2 and inserts a new installment amount that is equal to the donation amount minus the sum of all installments where the due date is set to be the payment date (Block 309). One or more PALEs are inserted into the ledger entries that correspond to the new installment (Block 311), before the delta calculation process completes.

If the sum of all paid payments is not greater than the donation amount as determined at Block 307, then the process applies case 1, where a new installment is inserted into the set of installments where the installment amount is equal to the sum of all payments minus the sum of all installments and where the due date is the payment date (Block 313). One or more PALEs are inserted into the ledger entries that correspond to the new installment (Block 311), before the delta calculation process completes.

Returning to the overall implied revenue recognition process of FIGS. 2A and 2B, after the pledge (i.e., donation) level delta is calculated, for example as set forth above, the process determines whether the pledge revenue delta is less than zero (Block 205). If the delta (i.e., the change in revenue) is less than zero, then the revenue recognition process sets unscheduled revenue to be equal to the absolute value of the delta (Block 207). If the delta is equal to or greater than zero or after the unscheduled revenue setting of Block 207, the revenue recognition process compiles a schedule of all payments and installments for the related donation/pledge/opportunity and sorts them in chronological order (Block 209). The process then sets a current date to the first date in the sorted schedule to start the process of sequential traversal of the payments and installments (Block 211).

To correlate the payments and installments with allocated funds, the revenue recognition process compiles and chronologically sorts a list of all funds (i.e., all GAUs) for the given donation/opportunity/pledge and set a current fund (i.e., GAU) to be the first in the sorted list (Block 213). The process then begins to iterate through the funds for the current date. For the current date and current fund, the revenue recognition process computes a current date fund revenue delta that is equal to the payments minus the revenues for this current date (Block 215). If the fund (i.e., GAU) revenue delta is not equal to zero (i.e., there is a change), then the revenue recognition process adjusts scheduled revenue for the current fund on the current date by the fund revenue delta amount (Block 219). After this adjustment is performed or if the fund revenue delta is zero, then the process determines if there are additional funds to process (Block 221). If there are additional funds to process, then the next fund is selected (Block 231) and the process performs the next iteration on the next fund starting at Block 215.

Once all of the funds have been processed (i.e., Block 221 assess to ‘no’), then the revenue recognition process determines if there are more dates in the schedule to process (Block 223). If there are more dates in the schedule to process, then the next date in chronological order is selected (Block 229) and the revenue recognition process processes the funds and for the next date starting at Block 213. Once all of the dates in the schedule of payments and installments have been processed (i.e., Block 223 evaluates as ‘no’), then the revenue recognition process determines if the updated (new) set of scheduled revenue is greater than the pledge revenue delta amount (Block 225). If the updated scheduled revenue remains greater than the pledge revenue delta, then the revenue recognition process caps (i.e., sets an upper bound) on the new revenue to not exceed the pledge revenue delta amount (Block 227) before the revenue recognition process completes. If there updated schedule revenue is not greater than the pledge revenue delta, then the process completes.

In some embodiments, the revenue recognition process ignores payment schedule changes that do not result in new revenue. Varying levels of optimization can be supported to reduce the storage requirements of the process by tracking or processing changes that do not affect revenue scheduling.

### Example Implementation

FIGS. 4A-4E are a flowchart of one example implementation of a process for implied revenue recognition. This example method determines how a new revenue amount, for example as determined by the example pledge revenue delta calculation of FIG. 1, will be recognized. The example implied revenue recognition process will create one or more PALEs to account for the three components of revenue according to what was modified in the payment schedule. It will also make adjustments to existing recognized revenue if necessary.

The example process can generate a list of PALES (palestoinsert) and installments (instoinsert) mapping (Block 401). A first opportunity in a set of opportunities is selected (Block 403). As mentioned, the illustrated example implied revenue recognition process has an entry condition where new revenue from updates has been calculated (Block 405) and the new revenue is greater than zero (Block 407). The illustration also indicates support for differing storage levels. The process begins with compiling list of PALEs and payment dates and sorts them in ascending chronological order (Block 409).

The example process handles each date sequentially. For each date (currDate) (starting at a first date Block 411), the example process compiles a list of all payment allocations for payments scheduled for currDate (Block 413) and starts at the first date (Block 415). The example process checks each payment allocation to see what has already been paid, by finding related PAPLEs for the same GAU and Payment and calculate scheduled payment amount for the current GAU by subtracting PAPLE amounts from the payment allocation amount (Block 417). Store this value in pmtAlloMap and repeat these steps for the next payment allocation, if any (steps 419-423).

When all payment allocations are processed, the example process compiles a list of PALEs scheduled for currDate (Block 425). The example process examines each PALE to see what has already been paid, finds related PAPLEs for the same GAU and installment as the PALE being processed, and calculates scheduled revenue amount for the current GAU by subtracting PAPLE amounts from the PALE amounts for that GAU (Blocks 427 and 429). The example process stores this value in paleMap (Block 431). The process repeats for the next PALE, if any until all PALEs are processed (Block 433 and 435).

The example process compiles a list of all GAU's in pmtAlloMap and in paleMap (Block 437). Each GAU in the list is processed to calculate the difference in revenue for that GAU for the current date, where revenue diff=payment allocations—PALEs, and if revenue difference is not zero, create a new PALE with that amount for the current GAU and current date. Add the new PALE to palesToInsert and increase the value paleAmount accordingly (Blocks 439-447). This process is repeated for the next GAU, if any until all GAUs are processed (Block 449 and 451). The example process can create a potential new installment for the current date based on paleAmount (Block 453) and add the new installment to newInsToInsertMap for the current date.

This process of Blocks 413 to 453 can be repeated for the next date, if any until all dates are processed (Block 455). After all dates are processed, the example implied revenue recognition process handles each new installment where if a current installment would result in recognizing more revenue than the amount on the opportunity, proportionally reduce Installment and all its PALEs so that the sum of Installments equals the amount on the Opportunity. If there is an existing Installment for the same date as the current Installment, combine both Installments into one (Blocks 459-463). The example process repeats these steps for the next installment, if any (Blocks 465 and 467). If additional opportunities are to be processed, the Blocks 413-467 are repeated for the next opportunity (Blocks 471 and 473).

When all opportunities have been processed, the example process inserts all new installments and updates existing ones that were modified in the set of stored installments (Block 475). The example process then fills out the Installment Id on all new PALEs (Block 477) and inserts new PALEs into the ledger (Block 479) before completing the process.

Electronic Device and Machine-Readable Media

One or more parts of the above implementations may include software and/or a combination of software and hardware. An electronic device (also referred to as a computing device, computer, etc.) includes hardware and software, such as a set of one or more processors coupled to one or more machine-readable storage media (e.g., magnetic disks, optical disks, read only memory (ROM), Flash memory, phase change memory, solid state drives (SSDs)) to store code (which is composed of software instructions and which is sometimes referred to as computer program code or a computer program) for execution on the set of processors and/or to store data. For instance, an electronic device may include non-volatile memory (with slower read/write times, e.g., magnetic disks, optical disks, read only memory (ROM), Flash memory, phase change memory, SSDs) and volatile memory (e.g., dynamic random access memory (DRAM), static random access memory (SRAM)), where the non-volatile memory persists code/data even when the electronic device is turned off or when power is otherwise removed, and the electronic device copies that part of the code that is to be executed by the set of processors of that electronic device from the non-volatile memory into the volatile memory of that electronic device during operation because volatile memory typically has faster read/write times. As another example, an electronic device may include a non-volatile memory (e.g., phase change memory) that persists code/data when the electronic device is turned off, and that has sufficiently fast read/write times such that, rather than copying the part of the code/data to be executed into volatile memory, the code/data may be provided directly to the set of processors (e.g., loaded into a cache of the set of processors); in other words, this non-volatile memory operates as both long term storage and main memory, and thus the electronic device may have no or only a small amount of volatile memory for main memory. In addition to storing code and/or data on machine-readable storage media, typical electronic devices can transmit code and/or data over one or more machine-readable transmission media (also called a carrier) (e.g., electrical, optical, radio, acoustical or other form of propagated signals—such as carrier waves, infrared signals). For instance, typical electronic devices also include a set of one or more physical network interface(s) to establish network connections (to transmit and/or receive code and/or data using propagating signals) with other electronic devices. Thus, an electronic device may store and transmit (internally and/or with other electronic devices over a network) code and/or data with one or more machine-readable media (also referred to as computer-readable media).

Electronic devices are used for a variety of purposes. For example, an electronic device (sometimes referred to as a server electronic device) may execute code that cause it to operate as one or more servers used to provide a service to another electronic device(s) (sometimes referred to as a client electronic device, a client computing device, or a client device) that executes client software (sometimes referred to as client code or an end user client) to communicate with the service. The server and client electronic devices may be operated by users respectively in the roles of administrator (also known as an administrative user) and end user.

Example Environment

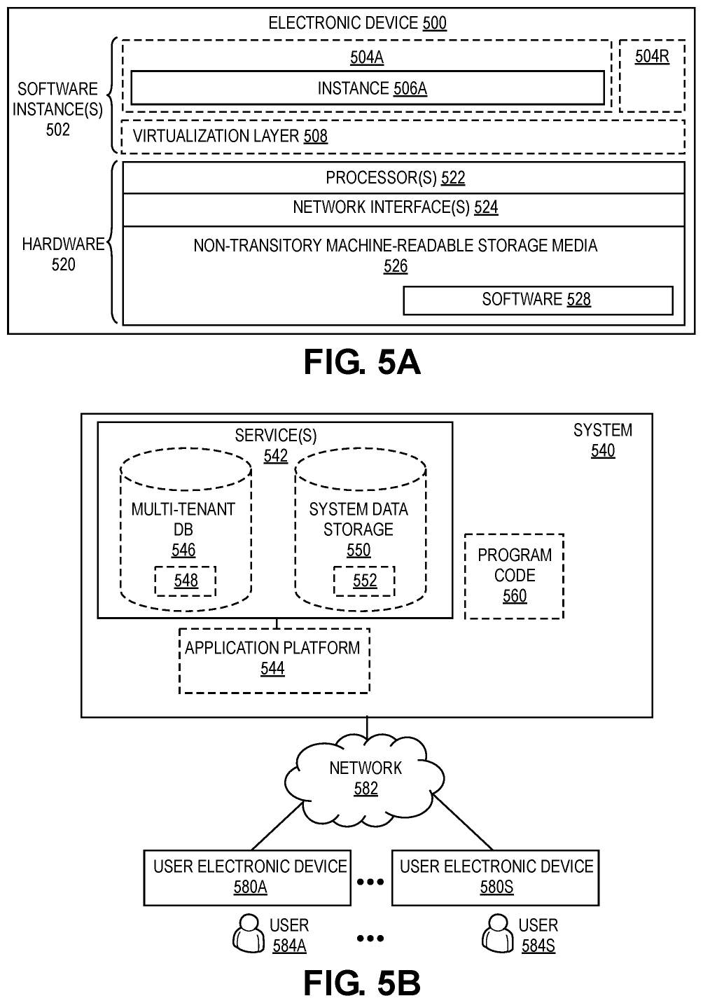

FIG. 5A is a block diagram illustrating an electronic device 500 according to some example implementations. FIG. 5A includes hardware 520 comprising a set of one or more processor(s) 522, a set of one or more network interfaces 524 (wireless and/or wired), and non-transitory machine-readable storage media 526 having stored therein software 528 (which includes instructions executable by the set of one or more processor(s) 522). Each of the previously described support organization and tenant organization user interactions with the donation management system and the services and resources of the donation management system itself may be implemented in one or more electronic devices 500. In one implementation: 1) each of the end user clients is implemented in a separate one of the electronic devices 500 (e.g., in user electronic devices operated by users of the tenant organization or organizations with supporting roles where the software 528 represents the software to implement end user clients to interface with the services and resources of the donation management system (e.g., a web browser, a native client, a portal, a command-line interface, and/or an application program interface (API) based upon protocols such as Simple Object Access Protocol (SOAP), Representational State Transfer (REST), etc.)); 2) the services and resources of the donation management system can be implemented in a separate set of one or more of the electronic devices 500 (e.g., a set of one or more server electronic devices where the software 528 represents the software to implement the service and resources of the donation management system); and 3) in operation, the electronic devices implementing the end user clients and the donation management services and resources would be communicatively coupled (e.g., by a network) and would establish between them (or through one or more other layers) connections for submitting resource requests to the authorization points and returning a set of permissions to the authorization points and end user clients. Other configurations of electronic devices may be used in other implementations (e.g., an implementation in which the end user client and the donation management system services are implemented on a set of shared electronic devices 500).

In electronic devices that use compute virtualization, the set of one or more processor(s) 522 typically execute software to instantiate a virtualization layer 508 and software container(s) 504A-R (e.g., with operating system-level virtualization, the virtualization layer 508 represents the kernel of an operating system (or a shim executing on a base operating system) that allows for the creation of multiple software containers 504A-R (representing separate user space instances and also called virtualization engines, virtual private servers, or jails) that may each be used to execute a set of one or more applications; with full virtualization, the virtualization layer 508 represents a hypervisor (sometimes referred to as a virtual machine monitor (VMM)) or a hypervisor executing on top of a host operating system, and the software containers 504A-R each represent a tightly isolated form of a software container called a virtual machine that is run by the hypervisor and may include a guest operating system; with para-virtualization, an operating system or application running with a virtual machine may be aware of the presence of virtualization for optimization purposes). Again, in electronic devices where compute virtualization is used, during operation an instance of the software 528 (illustrated as instance 506A) is executed within the software container 504A on the virtualization layer 508. In electronic devices where compute virtualization is not used, the instance 506A on top of a host operating system is executed on the “bare metal” electronic device 500. The instantiation of the instance 506A, as well as the virtualization layer 508 and software containers 504A-R if implemented, are collectively referred to as software instance(s) 502.

Alternative implementations of an electronic device may have numerous variations from that described above. For example, customized hardware and/or accelerators might also be used in an electronic device.

FIG. 5B is a block diagram of an environment where an end user clients or services and resources of the donation management system may be deployed, according to some implementations. A system 540 includes hardware (a set of one or more electronic devices) and software to provide service(s) 542, including the implied revenue recognition and accounting management system. The system 540 is coupled to user electronic devices 580A-S over a network 582. The service(s) 542 may be on-demand services that are made available to one or more of the users 584A-S working for one or more other organizations (sometimes referred to as outside users) so that those organizations do not need to necessarily be concerned with building and/or maintaining a system, but instead makes use of the service(s) 542 when needed (e.g., on the demand of the users 584A-S). The service(s) 542 may communication with each other and/or with one or more of the user electronic devices 580A-S via one or more Application Programming Interface(s) (APIs) (e.g., a Representational State Transfer (REST) API). The user electronic devices 580A-S are operated by users 584A-S.

In one implementation, the system 540 is a multi-tenant cloud computing architecture supporting multiple services, such as those of a donation management system. In other implementations, similar services can be applied to other services deployed in similar architectures such as customer relationship management (CRM) service (e.g., Sales Cloud by salesforce.com, Inc.), a contracts/proposals/quotes service (e.g., Salesforce CPQ by salesforce.com, Inc.), a customer support service (e.g., Service Cloud and Field Service Lightning by salesforce.com, Inc.), a marketing service (e.g., Marketing Cloud, Salesforce DMP, and Pardot by salesforce.com, Inc.), a commerce service (e.g., Commerce Cloud Digital, Commerce Cloud Order Management, and Commerce Cloud Store by salesforce.com, Inc.), communication with external business data sources (e.g., Salesforce Connect by salesforce.com, Inc.), a productivity service (e.g., Quip by salesforce.com, Inc.), database as a service (e.g., Database.com™ by salesforce.com, Inc.), Data as a Service (DAAS) (e.g., Data.com by salesforce.com, Inc.), Platform as a Service (PAAS) (e.g., execution runtime and application (app) development tools; such as, Heroku™ Enterprise, Thunder, and Force.com® and Lightning by salesforce.com, Inc.), an analytics service (e.g., Einstein Analytics, Sales Analytics, and/or Service Analytics by salesforce.com, Inc.), a community service (e.g., Community Cloud and Chatter by salesforce.com, Inc.), an Internet of Things (IoT) service (e.g., Salesforce IoT and IoT Cloud by salesforce.com, Inc.), industry specific services (e.g., Financial Services Cloud and Health Cloud by salesforce.com, Inc.), and/or Infrastructure as a Service (IAAS) (e.g., virtual machines, servers, and/or storage). For example, system 540 may include an application platform 544 that enables PAAS for creating, managing, and executing one or more applications developed by the provider of the application platform 544, users accessing the system 540 via one or more of user electronic devices 580A-S, or third-party application developers accessing the system 540 via one or more of user electronic devices 580A-S.

In some implementations, one or more of the service(s) 542 may utilize one or more multi-tenant databases 546 for tenant data 548, as well as system data storage 550 for system data 552 accessible to system 540. In certain implementations, the system 540 includes a set of one or more servers that are running on server electronic devices and that are configured to handle requests for any authorized user associated with any tenant (there is no server affinity for a user and/or tenant to a specific server). The user electronic device 580A-S communicate with the server(s) of system 540 to request and update tenant-level data and system-level data hosted by system 540, and in response the system 540 (e.g., one or more servers in system 540) automatically may generate one or more Structured Query Language (SQL) statements (e.g., one or more SQL queries) that are designed to access the desired information from the one or more multi-tenant database 546 and/or system data storage 550.

In some implementations, the service(s) 542 are implemented using virtual applications dynamically created at run time responsive to queries from the user electronic devices 580A-S and in accordance with metadata, including: 1) metadata that describes constructs (e.g., forms, reports, workflows, user access privileges, business logic) that are common to multiple tenants; and/or 2) metadata that is tenant specific and describes tenant specific constructs (e.g., tables, reports, dashboards, interfaces, etc.) and is stored in a multi-tenant database. To that end, the program code 560 may be a runtime engine that materializes application data from the metadata; that is, there is a clear separation of the compiled runtime engine (also known as the system kernel), tenant data, and the metadata, which makes it possible to independently update the system kernel and tenant-specific applications and schemas, with virtually no risk of one affecting the others. Further, in one implementation, the application platform 544 includes an application setup mechanism that supports application developers' creation and management of applications, which may be saved as metadata by save routines. Invocations to such applications, including the XYZ service, may be coded using Procedural Language/Structured Object Query Language (PL/SOQL) that provides a programming language style interface. Invocations to applications may be detected by one or more system processes, which manages retrieving application metadata for the tenant making the invocation and executing the metadata as an application in a software container (e.g., a virtual machine).

Network 582 may be any one or any combination of a LAN (local area network), WAN (wide area network), telephone network, wireless network, point-to-point network, star network, token ring network, hub network, or other appropriate configuration. The network may comply with one or more network protocols, including an Institute of Electrical and Electronics Engineers (IEEE) protocol, a 3rd Generation Partnership Project (3GPP) protocol, or similar wired and/or wireless protocols, and may include one or more intermediary devices for routing data between the system 540 and the user electronic devices 580A-S.

Each user electronic device 580A-S (such as a desktop personal computer, workstation, laptop, Personal Digital Assistant (PDA), smart phone, etc.) typically includes one or more user interface devices, such as a keyboard, a mouse, a trackball, a touch pad, a touch screen, a pen or the like, for interacting with a graphical user interface (GUI) provided on a display (e.g., a monitor screen, a liquid crystal display (LCD), etc.) in conjunction with pages, forms, applications and other information provided by system 540. For example, the user interface device can be used to access data and applications hosted by system 540, and to perform searches on stored data, and otherwise allow a user 584 to interact with various GUI pages that may be presented to a user 584. User electronic devices 580A-S might communicate with system 540 using TCP/IP (Transfer Control Protocol and Internet Protocol) and, at a higher network level, use other networking protocols to communicate, such as Hypertext Transfer Protocol (HTTP), FTP, Andrew File System (AFS), Wireless Application Protocol (WAP), File Transfer Protocol (FTP), Network File System (NFS), an application program interface (API) based upon protocols such as Simple Object Access Protocol (SOAP), Representational State Transfer (REST), etc. In an example where HTTP is used, one or more user electronic devices 580A-S might include an HTTP client, commonly referred to as a “browser,” for sending and receiving HTTP messages to and from server(s) of system 540, thus allowing users 584 of the user electronic device 580A-S to access, process and view information, pages and applications available to it from system 540 over network 582.

While the above description includes several exemplary implementations, those skilled in the art will recognize that the invention is not limited to the implementations described and can be practiced with modification and alteration within the spirit and scope of the appended claims. The description is thus illustrative instead of limiting.

What is claimed is:

1. A computer implemented method of revenue recognition for a donation management system comprising:
determining a difference in a payment schedule as a pledge level revenue delta for a donation;
compiling a schedule of payments and installments for the donation; and
adjusting revenue amounts for at least one installment in a schedule of installments to account for the pledge level revenue delta.

2. The method of claim 1, further comprising:
sorting the schedule of payments and installments in chronological order.

3. The method of claim 1, further comprising:
adjusting revenue allocated to each fund associated with the donation in response to the difference in payment schedule.

4. The method of claim 1, further comprising:
increasing total revenue for the donation in response to a sum of the schedule of payments exceeding a current revenue amount of the donation.

5. The method of claim 1, further comprising:
limiting an increase in implied revenue to a maximum of the pledge revenue delta.

6. The method of claim 1, further comprising:
generating at least one new installment record for the schedule of installments to accommodate a payment that exceeds the amount of the donation.

7. The method of claim 1, further comprising:
generating at least one new installment record for the schedule of installments that has an amount that is the donation amount minus a sum of all installments in the schedule of installments or a sum of all payments in the schedule of payments minus the sum of all installments.

8. A non-transitory machine-readable storage medium that provides instructions that, if executed by a processor, will cause said processor to perform operations implemented a method of revenue recognition for a donation management system comprising, the operations comprising:
determining a difference in a payment schedule as a pledge level revenue delta for a donation;
compiling a schedule of payments and installments for the donation; and
adjusting revenue amounts for at least one installment in a schedule of installments to account for the pledge level revenue delta.

9. The non-transitory machine-readable storage medium of claim 8, having further instructions stored therein that if executed cause the processor to perform further operations comprising:
sorting the schedule of payments and installments in chronological order.

10. The non-transitory machine-readable storage medium of claim 8, having further instructions stored therein that if executed cause the processor to perform further operations comprising:
adjusting revenue allocated to each fund associated with the donation in response to the difference in payment schedule.

11. The non-transitory machine-readable storage medium of claim 8, having further instructions stored therein that if executed cause the processor to perform further operations comprising:
increasing total revenue for the donation in response to a sum of the schedule of payments exceeding a current revenue amount of the donation.

12. The non-transitory machine-readable storage medium of claim 8, having further instructions stored therein that if executed cause the processor to perform further operations comprising:
limiting an increase in implied revenue to a maximum of the pledge revenue delta.

13. The non-transitory machine-readable storage medium of claim 8, having further instructions stored therein that if executed cause the processor to perform further operations comprising:
generating at least one new installment record for the schedule of installments to accommodate a payment that exceeds the amount of the donation.

14. The non-transitory machine-readable storage medium of claim 8, having further instructions stored therein that if executed cause the processor to perform further operations comprising:
generating at least one new installment record for the schedule of installments that has an amount that is the donation amount minus a sum of all installments in the schedule of installments or a sum of all payments in the schedule of payments minus the sum of all installments.

15. A computing device in a donation management system, the computing device implementing a method of managing access to resources of a nonprofit cloud platform comprising:
a non-transitory machine-readable medium having stored therein a revenue recognizer; and
one or more processors coupled to the non-transitory machine-readable medium, the one or more processors to execute the revenue recognizer, the revenue recognizer to determine a difference in a payment schedule as a pledge level revenue delta for a donation, to compile a schedule of payments and installments for the donation, and adjust revenue amounts for at least one installment in a schedule of installments to account for the pledge level revenue delta.

16. The computing device of claim 15, wherein the revenue recognizer is further to sort the schedule of payments and installments in chronological order.

17. The computing device of claim 15, wherein the revenue recognizer is further to adjust revenue allocated to each fund associated with the donation in response to the difference in payment schedule.

18. The computing device of claim 15, wherein the revenue recognizer is further to increase total revenue for the donation in response to a sum of the schedule of payments exceeding a current revenue amount of the donation.

19. The computing device of claim 15, wherein the revenue recognizer is further to limit an increase in implied revenue to a maximum of the pledge revenue delta.

20. The computing device of claim 15, wherein the revenue recognizer is further to generate at least one new installment record for the schedule of installments to accommodate a payment that exceeds the amount of the donation.

21. The computing device of claim 15, wherein the revenue recognizer is further to generate at least one new installment record for the schedule of installments that has an amount that is the donation amount minus a sum of all installments in the schedule of installments or a sum of all payments in the schedule of payments minus the sum of all installments.
